(19) United States
(12) Patent Application Publication
(10) Pub. No.: US 2018/0248415 A1
(43) Pub. Date: Aug. 30, 2018

(54) POWER TRANSMISSION DEVICE

(71) Applicant: Daisuke Yoshizawa, Aichi (JP)

(72) Inventor: Daisuke Yoshizawa, Aichi (JP)

(73) Assignee: OMRON AUTOMOTIVE ELECTRONICS CO., LTD., Aichi (JP)

(21) Appl. No.: 15/898,179

(22) Filed: Feb. 15, 2018

(30) Foreign Application Priority Data
Feb. 28, 2017 (JP) 2017-037077

(51) Int. Cl. H02J 50/90; H02J 50/10; H02J 50/70

(52) U.S. Cl. CPC H02J 50/90; H02J 7/025; H02J 50/70; H02J 50/10

(57) ABSTRACT

A power transmission device wirelessly transmits power to a power receiving device. The power transmission device includes: a power transmission circuit that generates an electric signal; a first power transmission coil that transmits the power by a first transmission method using the electric signal generated by the power transmission circuit; a second power transmission coil that transmits the power by a second transmission method using the electric signal generated by the power transmission circuit; a second power transmission coil position moving unit that moves a position of the second power transmission coil in a direction perpendicular to a coil surface; and a control unit that controls the second power transmission coil position moving unit to move the second power transmission coil, in a case where the power transmission circuit generates the electric signal so as to transmit the power from the second power transmission coil.

### CROSS-REFERENCES TO RELAYED APPLICATIONS

This application is based upon and claims the benefit of priority from Japanese Patent Application No. 2017-037077, filed on Feb. 28, 2017, the entire contents of which are incorporated herein by reference.

### FIELD

One or more embodiments of the invention relate to a power transmission device which wirelessly transmits power to a power receiving device, and more particularly relate to a power transmission device which transmits power in a contactless manner by using two different coexisting coils.

### BACKGROUND

In the related art, a power transmission device has been proposed which wirelessly transmits power to a power receiving device. For example, JP-A-2015-144508 discloses a wireless power transmission system which can correspond to two transmission methods and can suppress poor power transmission efficiency from the power transmission device to the power receiving device. The wireless power transmission system wirelessly transmits the power from the power transmission device to the power receiving device by using magnetic field coupling between a power transmission coil and a power receiving coil. The power transmission device has a power transmission circuit that generates an electric signal for power transmission, a first power transmission coil that corresponds to a first transmission method, a second power transmission coil that corresponds to a second transmission method, a first magnetic substance on which the first power transmission coil is placed, a second magnetic substance on which the second power transmission coil is placed, and a power supply surface on which the power receiving device is placed. A first attachment surface of the first magnetic substance and a second attachment surface of the second magnetic substance are located on a lower side of the power supply surface, and are disposed on the same plane parallel to the power supply surface. In the power transmission device, a magnetic flux generated by the first power transmission coil is concentrated inside the first magnetic substance. In this manner, the power transmission device can suppress the magnetic field coupling between the first power transmission coil and the second power transmission coil. In addition, a magnetic flux generated by the second power transmission coil is concentrated inside the second magnetic substance. In this manner, the power transmission device can suppress the magnetic field coupling between the first power transmission coil and the second power transmission coil.

Pamphlet of International Publication No. WO2011/070637 discloses a magnetic field resonance wireless power transmission system whose power transmission efficiency is improved by transmitting power using magnetic field resonance from the power transmission device to the power receiving device. A magnetic field resonance power transmission device in the magnetic field resonance wireless power transmission system includes a resonance coil, a power supply unit that supplies the power to the resonance coil so as to generate a magnetic field, a magnetic substance that changes the magnetic field generated by the resonance coil, and a position adjustment unit that adjusts a position relationship between the resonance coil and the magnetic substance. The power supply unit causes the resonance coil to generate an alternating current having a frequency the same as a transmission frequency. In a case where a measured current flowing through the resonance coil and a measured magnetic field do not reach the maximum value, the position adjustment unit adjusts a position of a magnetic field shield by rotating a position adjustment screw so that both of these reach the maximum value. Through this adjustment, a resonance frequency of the resonance coil can be adjusted to a target frequency.

JP-A-2016-005311 discloses a contactless power supply device for vehicle in which each position of a power supply coil of a housing and a power receiving coil of a portable terminal is automatically adjusted. The contactless power supply device for vehicles is installed inside a passenger compartment of a vehicle, and can support the portable terminal. The contactless power supply device for vehicles includes the housing including the power supply coil for supplying power to the portable terminal, an ECU, and a left arm and a right arm which support the portable terminal. Based on a distance between the power supply coil and the left arm and the right arm and a shape of the portable terminal detected by the ECU, the ECU detects a difference from a distance between the power receiving coil of the portable terminal and a portion of the portable terminal. The ECU controls the left arm and the right arm to move so that the difference between the distances falls within a predetermined range. Each position of the left arm and the right arm is automatically adjusted so that the power supply coil portion of the housing and a center position of the power receiving coil portion of the portable terminal are close to each other. Therefore, the contactless power supply device for vehicles can efficiently supply the power to the portable terminal, even if an occupant does not manually adjust the position.

### SUMMARY

In recent years, while portable terminals such as smartphones have come into wide use, many standards for contactless charging have been introduced. For example, the Qi standard, the PMA standard, and the A4WP standard have been introduced so far. Some of the standards are mutually compatible or incompatible in terms of hardware and software. The Qi standard and the PMA standard adopt an electromagnetic induction method, and can share the hardware (power transmission coil). On the other hand, the A4WP standard adopts a magnetic field resonance method, and is incompatible with the Qi standard in using the power transmission coil. Thus, the A4WP standard requires a dedicated power transmission coil. In view of usability of users, it is preferable that a single contactless charger can correspond to many standards.

However, if both the power transmission coil conforming to the Qi standard/the PMA standard and the power transmission coil conforming to the A4WP standard are disposed in a miniaturized device, the coils interfere with each other due to mutual inductance. Consequently, an inductance value fluctuates, thereby causing poor charging performance. It is understood that the poor performance conspicuously occurs in a case of the magnetic field resonance method as in the A4WP standard.

One or more embodiments of the invention are made in view of the above-described circumstances, and an object thereof is to provide a power transmission device having satisfactory charging efficiency by reducing the influence of mutual inductance in two power transmission coils conforming to mutually different standards.

In order to solve the above-described problem, there is provided a power transmission device which wirelessly transmits power to a power receiving device. The power transmission device includes a power transmission circuit that generates an electric signal, a first power transmission coil that transmits the power by a first transmission method using the electric signal generated by the power transmission circuit, a second power transmission coil that transmits the power by a second transmission method using the electric signal generated by the power transmission circuit, a second power transmission coil position moving unit that moves a position of the second power transmission coil in a direction perpendicular to a coil surface, and a control unit that controls the second power transmission coil position moving unit to move the second power transmission coil, in a case where the power transmission circuit generates the electric signal so as to transmit the power from the second power transmission coil.

According to this configuration, in a case where the power is transmitted from one of the power transmission coils, the position of the power transmission coil is moved so that a resonance frequency of the power transmission side coil coincides with a resonance frequency of the power receiving side coil. In this manner, it is possible to provide the power transmission device having satisfactory charging efficiency by reducing the influence of mutual inductance.

Furthermore, the control unit may control the second power transmission coil position moving unit to move the second power transmission coil so as to optimize a value of the power flowing in the second power transmission coil.

According to this configuration, a position of one of the power transmission coils is moved. In this manner, it is possible to obtain the optimum value of the power flowing in one of the power transmission coils by searching for the value of the power.

Furthermore, the power transmission device may include a current value measuring unit that measures a value of a current flowing in the second power transmission coil. The value of the power flowing in the second power transmission coil may be optimized by selecting a position of the second power transmission coil at which the current value measuring unit indicates a highest current value of measured current values in a movable range of the second power transmission coil.

According to this configuration, the position of one of the power transmission coils is selected when the highest current value is indicated in one coil, thereby improving the charging efficiency achieved by one coil.

Furthermore, the value may be repeatedly optimized by repeatedly moving the position of the second power transmission coil.

According to this configuration, the position of one of the power transmission coils is repeatedly moved. In this manner, efficient charging can be continuously performed by one coil.

Furthermore, the first power transmission coil may correspond to an electromagnetic induction method. The second power transmission coil may correspond to a magnetic field resonance method.

According to this configuration, in a case where the power is transmitted from a magnetic field resonance type power transmission coil in a charging device conforming to both the magnetic field resonance method and the electromagnetic induction method, the position of magnetic field resonance type power transmission coil is moved so that the resonance frequency of the magnetic field resonance type power transmission side coil coincides with the resonance frequency of the power receiving side coil. In this manner, the influence of the mutual inductance is reduced, and thus, it is possible to provide the power transmission device having the satisfactory charging efficiency when charging is performed by the magnetic field resonance type power transmission coil.

As described above, according to one or more embodiments of the invention, it is possible to provide the power transmission device having the satisfactory charging efficiency by reducing the influence of the mutual inductance in two power transmission coils conforming to mutually different standards.

### BRIEF DESCRIPTION OF THE DRAWINGS

FIG. 1A is a plan view (excluding a case including a power supply surface) of a power transmission device according to a first embodiment of the invention;

FIG. 1B is a side view (illustrates only the power supply surface in the case);

FIG. 2A is a side view (illustrates only the power supply surface in the case) in a case where power is transmitted from an electromagnetic induction type coil of the power transmission device according to the first embodiment of the invention;

FIG. 2B is a side view (illustrates only the power supply surface in the case) in a case where power is transmitted from a magnetic field resonance type coil;

FIG. 3 is a flowchart illustrating a control method used in the power transmission device according to the first embodiment of the invention;

FIG. 4A is a schematic view illustrating that a current flows in an electromagnetic induction coil due to a magnetic flux generated by a magnetic field resonance coil in a power transmission device in the related art; and

FIG. 4B is a schematic view illustrating that the power transmission device is coupled to a power receiving device by the current flowing in the electromagnetic induction coil.

### DETAILED DESCRIPTION

In embodiments of the invention, numerous specific details are set forth in order to provide a thorough understanding of the invention. However, it will be apparent to one of ordinary skill in the art that the invention may be practiced without these specific details. In other instances, well-known features have not been described in detail to avoid obscuring the invention.

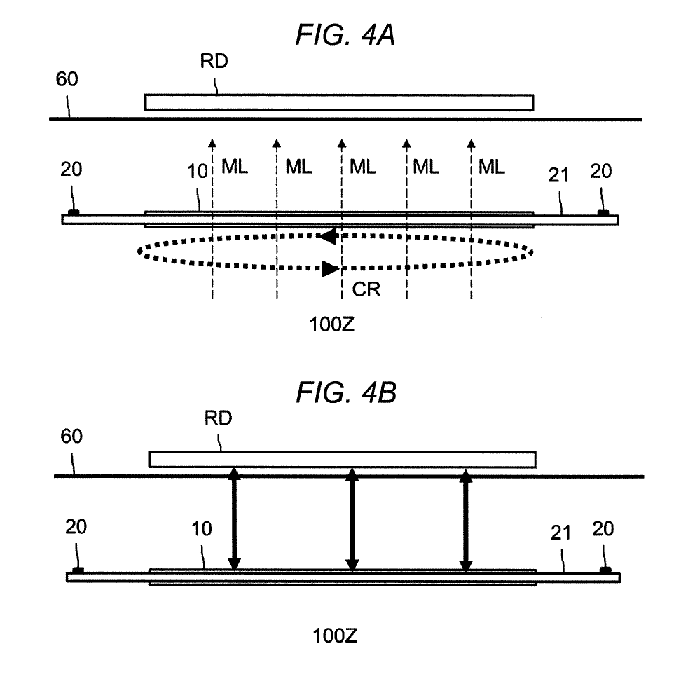

Hereinafter, an embodiment of the invention will be described with reference to the drawings. First, referring to FIGS. 4A and 4B, a power transmission device 100Z in the related art will be described. In the drawings, a housing of the power transmission device 100Z is not illustrated, and a coil accommodated inside the housing is mainly illustrated. The power transmission device 100Z wirelessly transmits power to a power receiving device RD such as a smartphone. The power receiving device RD internally has a power receiving function which is applicable to a transmission method of the power transmission device 100Z, and is placed on a power supply surface 60 of the housing of the power transmission device 100Z. In this manner, the power receiving device RD is charged by receiving power supplied from the power transmission device 100Z.

The power transmission device 100Z includes a first power transmission coil 10 that transmits the power by using an electromagnetic induction method, and a second power transmission coil 20 that transmits the power by using a magnetic field resonance method. The electromagnetic induction method is used in transmitting the power by causing a power receiving side coil to generate an electromotive force by means of electromagnetic induction caused due to a change in a magnetic field generated by a power transmission side coil. The magnetic field resonance method is used in transmitting the power by matching a frequency of the power transmission side coil and a frequency of the power receiving side coil, and in such a way that vibrations of the magnetic field generated by a current flowing in the power transmission side coil are transmitted to a power receiving side resonance circuit which resonates at the same frequency.

According to the electromagnetic induction method, a magnitude of the magnetic flux greatly affects power transmission efficiency, and a magnitude of a coupling coefficient between the power transmitting side coil and the power receiving side coil determines a magnitude of the transmitted power. The magnitude of the coupling coefficient is affected by a distance between both coils or a coincidence degree of coil center positions. According to the magnetic field resonance method, the magnitude of the magnetic flux may be small. Instead, a height of peaky performance (property which sensitively responds to a prescribed frequency) in the power transmitting side coil and the power receiving side coil (antenna) greatly affects the power transmission efficiency. According to the magnetic field resonance method, the magnitude of the magnetic flux rarely relates to the power transmission efficiency. Accordingly, the magnetic field resonance method has a characteristic that the power can be transmitted even if the power transmission side coil and the power receiving side coil are separated from each other. On the other hand, the power transmission efficiency is likely to receive the influence of surrounding coils or the magnetic flux. That is, in the power transmission efficiency according to the magnetic field resonance method, it is important how closely a resonance frequency of the power transmission side coil can coincide with a resonance frequency of the power receiving side coil.

In particular, in the power transmission device such as the power transmission device 100Z including the first power transmission coil 10 using the electromagnetic induction method and the second power transmission coil 20 using the magnetic field resonance method, the power transmission device receives the influence of mutual inductance between the power transmission side coil and the power receiving side coil. That is, the reason is as follows. In the vicinity of the second power transmission coil 20 using the magnetic field resonance method, the first power transmission coil 10 using its own electromagnetic induction method is present, and the power receiving coil of the power receiving device RD approaching the vicinity in order to improve the power transmission efficiency in the electromagnetic induction method is also present.

As illustrated in the drawings, in the power transmission device 100Z, the first power transmission coil 10 using the electromagnetic induction method and the second power transmission coil 20 using the magnetic field resonance method are located in the vicinity of the power supply surface 60, that is, in the vicinity of the power receiving device RD. Both of these are located with approximately the same distance from the power receiving side coil of the power receiving device RD. FIG. 4A illustrates that an upward magnetic flux ML is generated by a current flowing in the second power transmission coil 20 using the magnetic field resonance method. In this case, the magnetic flux ML interlinks with the first power transmission coil 10 using the electromagnetic induction method, and in compliance with the interlinkage, a current CR flows in the first power transmission coil 10 using the electromagnetic induction method.

In this case, as illustrated in FIG. 4B, coupling occurs between the first power transmission coil 10 using the electromagnetic induction method and the power receiving side coil of the power receiving device RD. If the coupling occurs, the mutual inductance is changed, and the resonance frequency of the power receiving side coil fluctuates. Consequently, due to high peaky performance, the second power transmission coil 20 using the magnetic field resonance method comes to have poor power transmission efficiency. If a smartphone of the power receiving device RD is moved on the power supply surface 60 and a distance fluctuates between the first power transmission coil 10/the second power transmission coil 20 and the power receiving side coil, the mutual inductance may vary in some cases. If the mutual inductance fluctuates as described above, the fluctuation causes poor charging performance of the power transmission device 100Z which charges the power receiving device RD.

### First Embodiment

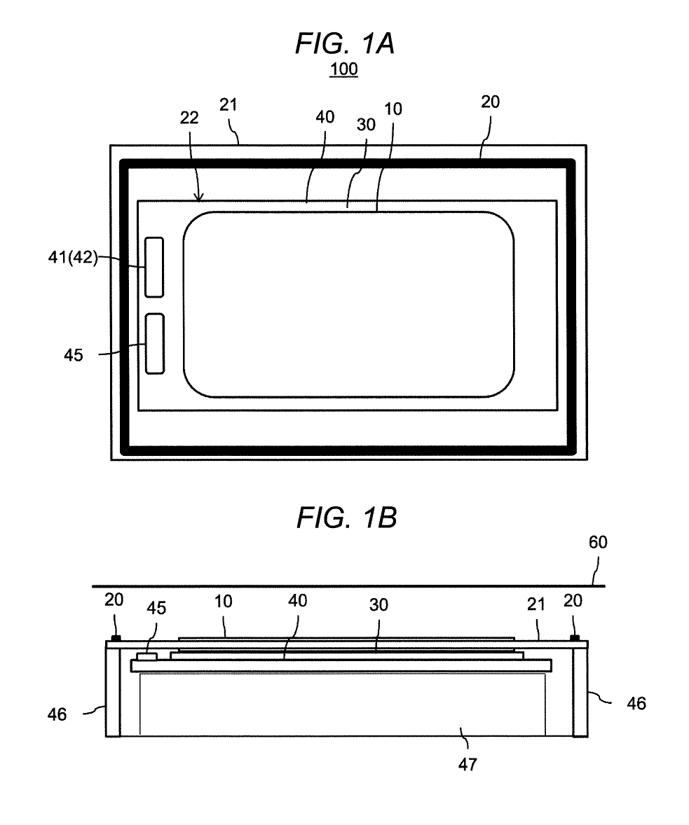

Referring to FIG. 1, the power transmission device 100 according to the present embodiment will be described. FIG. 1A does not illustrate a case of the power transmission device 100, and illustrates only an internal coil. FIG. 1B illustrates only the power supply surface 60 in the case. The power transmission device 100 wirelessly transmits the power to the power receiving device RD such as the portable terminal, and has the power supply surface 60 on which the power receiving device RD is placed. As a so-called wireless charging method of wirelessly supplying the power to the power receiving device RD such as the portable terminal, the power transmission device 100 employs both the electromagnetic induction method using electromagnetic waves having frequencies of approximately several tens kHz to several hundreds kHz and the magnetic field resonance method using electromagnetic waves having frequencies of approximately several MHz to several tens MHz.

In order to correspond to the two different wireless charging methods, the power transmission device 100 includes the first power transmission coil 10 that transmits the power by using the electromagnetic induction method (first transmission method) and the second power transmission coil 20 that transmits the power by using the magnetic field resonance method (second transmission method). More specifically, the power transmission device 100 includes a control board 40 having a rectangular shape in a plan view, a magnetic substance 30 for strengthening a magnetic field in a rectangular plate shape on the control board 40, a first power transmission coil 10 disposed so as to be stacked on the power supply surface 60 side of the magnetic substance 30, a second power transmission coil board 21 disposed to face the control board 40 in parallel and electrically connected to the control board 40, a second power transmission coil 20 disposed on the second power transmission coil board 21, a second power transmission coil position moving unit 46 that moves the second power transmission coil board 21, and a control unit 45 that controls the second power transmission coil position moving unit 46.

The first power transmission coil 10 is disposed inside an opening portion 22 of the second power transmission coil board 21. Therefore, the first power transmission coil 10 is disposed at a position where the distance from the power supply surface 60 of the first power transmission coil 10 is substantially the same as the distance from the power supply surface 60 of the second power transmission coil 20. The first power transmission coil 10 is located on the coil center side of the second power transmission coil 20. The magnetic substance 30 is configured to include a material having magnetic permeability of 1 or more such as ferrite, and has a rectangular plate shape. A shape in a plan view is substantially the same as the rectangular shape of the opening portion 22 of the second power transmission coil board 21. The magnetic substance 30 is disposed so as to coincide with the first power transmission coil 10. The first power transmission coil 10 is a spiral coil wound in a rectangular and annular shape by using a wiring pattern of conductors formed on the control board 40.

The second power transmission coil 20 is disposed in a frame portion interposed between the opening portion 22 and an outer peripheral portion of the second power transmission coil board 21. The second power transmission coil 20 is a rectangular shaped antenna formed by a wiring pattern of conductors formed on the second power transmission coil board 21. Unlike the first power transmission coil 10 coupled using the strength of the magnetic flux, the second power transmission coil 20 is not necessarily wound several times for the magnetic field resonance. The second power transmission coil 20 resonates at a predetermined frequency by using its own inductance and stray capacitance.

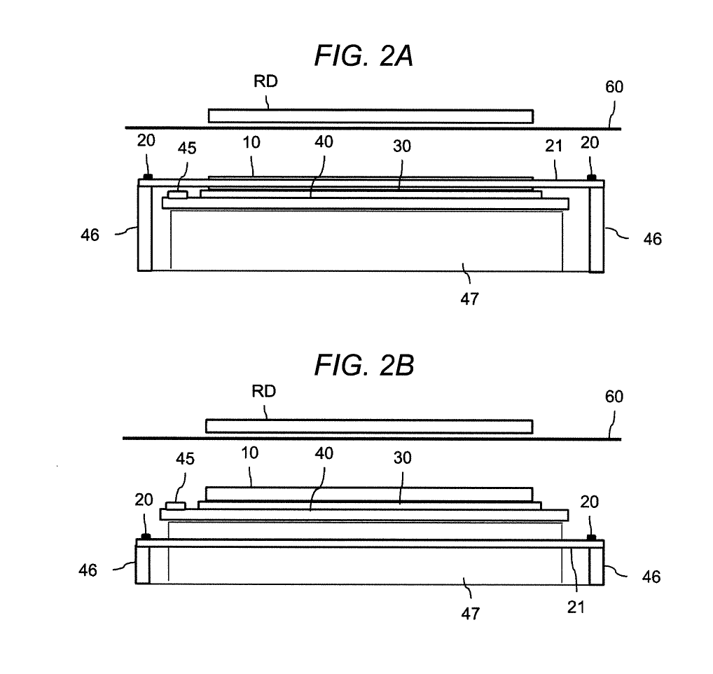

The second power transmission coil board 21 is supported by the second power transmission coil position moving unit 46. The second power transmission coil position moving unit 46 expands and contracts, thereby moving the second power transmission coil board 21 in a direction perpendicular to the coil surface (upward and downward direction in the drawing). As illustrated in FIGS. 2A and 2B, the control board 40 is supported and fixed by the first power transmission coil support unit 47, but is slightly smaller than the opening portion 22 of the second power transmission coil board 21. Accordingly, even if the second power transmission coil board 21 moves in the direction perpendicular to the coil surface, the control board 40 can pass through the opening portion 22. In the present embodiment, the second power transmission coil position moving unit 46 moves the second power transmission coil board 21 in the upward and downward direction by expanding and contracting in the axial direction for supporting the second power transmission coil board 21. However, any known technique or mechanism capable of moving the second power transmission coil board 21 in the direction perpendicular to the coil surface may be used. For example, the second power transmission coil position moving unit 46 may be a mechanism for supporting the second power transmission coil board 21 from a side surface and moving the second power transmission coil board 21 in a direction perpendicular to a board surface of the second power transmission coil board 21.

In a case where the control unit 45 generates an electric signal so that a power transmission circuit 41 transmits the power from the first power transmission coil 10 using the electromagnetic induction method, it is preferable to apply a strong magnetic flux to the power receiving device RD. Accordingly, for example, as illustrated in FIG. 2A, the first power transmission coil 10 is disposed at a position relatively close to the power supply surface 60. On the other hand, in a case where the control unit 45 generates the electric signal so that the power transmission circuit 41 transmits the power from the second power transmission coil 20 using the magnetic field resonance method, the control unit 45 controls the second power transmission coil position moving unit 46, and moves the second power transmission coil 20 in the direction perpendicular to the coil surface. FIG. 2A illustrates a state where the second power transmission coil 20 is located in substantially the same distance from the first power transmission coil 10 and the power supply surface 60. FIG. 2B illustrates a state where the second power transmission coil position moving unit 46 moves the second power transmission coil board 21 so as to be away from the power supply surface 60 (downward in the drawing).

FIG. 2B illustrates an example in which the second power transmission coil position moving unit 46 moves the second power transmission coil board 21 so as to be away from the power supply surface 60. However, the second power transmission coil board 21 may be moved so as to be close to the power supply surface 60. In a case where the power is transmitted from the second power transmission coil 20 using the magnetic field resonance method, a position of the second power transmission coil 20 is determined while the position of the second power transmission coil 20 is changed as will be described later. In this way, in a case where the power is transmitted from the second power transmission coil 20 using the magnetic field resonance method in the charging device conforming to both standards of the magnetic field resonance method and the electromagnetic induction method standards, the position of the second power transmission coil′20 is moved so that the resonance frequency of the second power transmission coil 20 coincides with the resonance frequency of the coil of the power receiving device RD. In this manner, it is possible to provide the power transmission device 100 having the satisfactory charging efficiency by reducing the influence of the mutual inductance.

The power transmission device 100 further includes the power transmission circuit 41 that generates the electric signal for the first power transmission coil 10 and the second power transmission coil 20, on the control board 40. The power transmission circuit 41 internally has a first power transmission circuit corresponding to the first power transmission coil 10 and a second power transmission circuit corresponding to the second power transmission coil 20, which are configured to include a circuit such as an inverter circuit. The first power transmission circuit generates the electric signal for power transmission corresponding to the electromagnetic induction method. As the electric signal corresponding to the electromagnetic induction method, the electric signal of an alternating current having a frequency of approximately several tens kHz to several hundreds kHz is usually used. The second power transmission circuit generates the electric signal for power transmission corresponding to the magnetic field resonance method. As the electric signal corresponding to the magnetic field resonance method, the electric signal of the alternating current having a frequency of approximately several MHz to several tens MHz is usually used.

In addition to the power transmission circuit 41, the control board 40 has a detection circuit, a control circuit, and a switch (not illustrated). Based on a predetermined control signal or operation, the control board 40 can select whether to transmit the power by using any one of the electromagnetic induction method and the magnetic field resonance method. The power transmission circuit 41 applies the generated electric signal to the first power transmission coil 10 or the second power transmission coil 20 using selected method. The detection circuit is installed in the vicinity of the power supply surface 60, and detects a signal of the power receiving device RD. In this manner, for example, based on the frequency of the received signal, the detection circuit determines whether the power receiving device RD is the power receiving device using the electromagnetic induction method or the power receiving device using the magnetic field resonance method. If necessary, the power transmission circuit 41 can simultaneously apply the electric signals to the first power transmission coil 10 and the second power transmission coil 20.

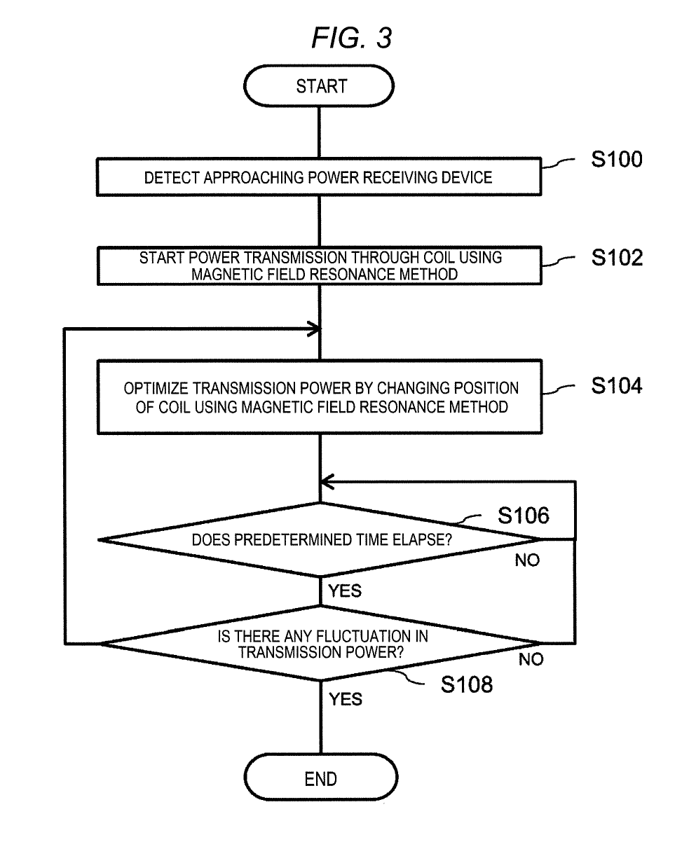

Referring to FIG. 3, a control method when the power transmission circuit 41 generates the electric signal for the first power transmission coil 10 and the second power transmission coil 20 will be described. The reference numeral S in the flowchart means a step. The drawing is illustrated for describing a case of charging the power receiving device RD using the magnetic field resonance method. In S100, the power transmission device 100 causes the detection circuit to detect whether the power receiving device RD using any method approaches the power supply surface 60. Based on the frequency, the power transmission device 100 detects that the power receiving device RD using the magnetic field resonance method approaches the power supply surface 60. In S102, in order to transmit the power to the power receiving device RD using the magnetic field resonance method, the power transmission circuit 41 of the power transmission device 100 generates and applies the electric signal having the frequency corresponding to the magnetic field resonance method, to the second power transmission coil 20. In this manner, the power transmission device 100 starts power transmission through the second power transmission coil 20 using the magnetic field resonance method.

The power transmission circuit 41 generates and applies the electric signal so as to transmit the power to the second power transmission coil 20 using the magnetic field resonance method. In S104, the control unit 45 controls the second power transmission coil position moving unit 46, and moves the second power transmission coil 20, thereby optimizing a value of the power flowing in the first power transmission coil 10. Determining how far is suitable for the distance between the second power transmission coil 20 and the coil of the power receiving device RD varies depending on a position and performance of the power receiving device RD. Accordingly, a position to which the second power transmission coil 20 is moved cannot be determined as one position.

Therefore, it is preferable that the control unit 45 moves the second power transmission coil position moving unit 46, for example, every 1 mm continuously in a direction away from the power supply surface 60 or in a direction close to the power supply surface 60. In this way, the position of the second power transmission coil 20 using the magnetic field resonance method is continuously moved so as to search for values of the power. Accordingly, it is possible to obtain optimum value of the power flowing in the second power transmission coil 20.

The value of the power transmitted from the second power transmission coil 20 may be detected by using a current value of the second power transmission coil 20. That is, the power transmission device 100 may further include a current value measuring unit 42 that measures the current value flowing in the second power transmission coil 20. The current value flowing in the second power transmission coil 20 may be optimized by selecting the position of the second power transmission coil 20 when the highest current value is indicated within the current values measured by the current value measuring unit 42 in a range where the second power transmission coil 20 is moved. In this way, the position of the second power transmission coil 20 when the highest current value is indicated is selected in the second power transmission coil 20 using the electromagnetic induction method. In this manner, the charging efficiency obtained by the second power transmission coil 20 is improved.

In S106, the power transmission circuit 41 waits for a predetermined time to elapse after the transmission power is optimized in S104. In S108, the power transmission circuit 41 re-detects the power amount (or the current value flowing in the second power transmission coil 20) transmitted from the second power transmission coil 20, and checks whether or not there is any fluctuation. As long as there is no fluctuation, the power transmission circuit 41 determines that the currently optimized position of the second power transmission coil 20 position is valid, and at the position, the power transmission circuit 41 continues the power transmission from the second power transmission coil 20 using the electromagnetic induction method. On the other hand, in a case where there is any fluctuation, in S104, the power transmission circuit 41 continuously changes the position of the second power transmission coil 20 so as to optimize the position of the second power transmission coil 20. In this way, the position of the second power transmission coil 20 is repeatedly moved. In this manner, efficient charging can be continuously performed by the second power transmission coil 20 using the magnetic field resonance method.

While the invention has been described with respect to a limited number of embodiments, those skilled in the art, having benefit of this disclosure, will appreciate that other embodiments can be devised which do not depart from the scope of the invention as disclosed herein. According, the scope of the invention should be limited only by the attached claims.

1. A power transmission device which wirelessly transmits power to a power receiving device, the power transmission device comprising:
a power transmission circuit that generates an electric signal;
a first power transmission coil that transmits the power by a first transmission method using the electric signal generated by the power transmission circuit;
a second power transmission coil that transmits the power by a second transmission method using the electric signal generated by the power transmission circuit;
a second power transmission coil position moving unit that moves a position of the second power transmission coil in a direction perpendicular to a coil surface; and
a control unit that controls the second power transmission coil position moving unit to move the second power transmission coil, in a case where the power transmission circuit generates the electric signal so as to transmit the power from the second power transmission coil.

2. The power transmission device according to claim 1,
wherein the control unit controls the second power transmission coil position moving unit to move the second power transmission coil so as to optimize a value of the power flowing in the second power transmission coil.

3. The power transmission device according to claim 2, further comprising:
a current value measuring unit that measures a value of a current flowing in the second power transmission coil,
wherein the value of the power flowing in the second power transmission coil is optimized by selecting a position of the second power transmission coil at which the current value measuring unit indicates a highest current value of measured current values in a movable range of the second power transmission coil.

4. The power transmission device according to claim 3,
wherein the value is repeatedly optimized by repeatedly moving the position of the second power transmission coil.

5. The power transmission device according to claim 1,
wherein the first power transmission coil corresponds to an electromagnetic induction method, and
wherein the second power transmission coil corresponds to a magnetic field resonance method.
